(19) United States
(12) Patent Application Publication
(10) Pub. No.: US 2026/0221744 A1
(43) Pub. Date: Jul. 30, 2026

(54) Mounting Device for a Busbar

(71) Applicant: Bayerische Motoren Werke Aktiengesellschaft, Muenchen (DE)

(72) Inventors: Daniel BSCHORER, Muenchen (DE); Gerhard VIEHBACHER, Karlsfeld (DE)

(21) Appl. No.: 19/148,818

(22) PCT Filed: Mar. 13, 2024
(86) PCT No.: PCT/DE2024/100202

§ 371 Date: Jul. 17, 2025

(30) Foreign Application Priority Data
Mar. 14, 2023 (DE) 10 2023 106 348.0

(51) Int. Cl. H02G 5/02

(52) U.S. Cl. CPC H02G 5/025

(57) ABSTRACT

A mounting device for a busbar includes a mounting element having a main part and at least one locking device that has a detent element spaced apart from the main part. A connection element can be accommodated between the detent element and the main part.

### BACKGROUND AND SUMMARY

The invention relates to a mounting device for a busbar, in particular in a motor vehicle, having a mounting element, with a basic body and with at least one locking device which has a detent lug, and a connector element which is capable of being received between the detent lug and the basic body. In addition, the invention relates to a busbar having such a mounting device, in particular for arrangement in a motor vehicle.

High-voltage storage devices—also designated as traction batteries or traction accumulators—are known for the purpose of making electrical energy available in connection with the supply of energy to electric drives of vehicles. Such traction batteries are typically supplied with energy by means of charging stations external to the vehicle, in order to be able to make this energy available for the operation of the vehicle. For the purpose of conducting electrical energy within the vehicle, busbars, for instance, are employed that include cables for conducting current and/or for communicating data.

For the linkage of, in particular, rigid busbars in electrically powered vehicles, mountings are typically necessary, in order to fasten these busbars relative to the vehicle. By reason of manufacturing tolerances and thermal expansions, a compensation of motion, particularly with respect to predetermined rotational and/or translational motions, should be made possible in the region of the linkage or fastening. In this connection, relative motions should, in particular, not occur between the holder and the busbar, in order to avoid wear to the busbar or cable.

Against this background, it is an object of the invention to improve a fastening option for busbars, in particular in a motor vehicle. In particular, a mounting device for a busbar is to be improved, in order to enable a compensation of motion between the busbar and the linkage-point in the motor vehicle.

This object is achieved by virtue of a mounting device for a busbar and by virtue of a busbar having such a mounting device, in accordance with the independent claim(s). The dependent claims relate to advantageous developments of the invention.

According to a first aspect, a mounting device for a busbar, in particular for a motor vehicle, is specified, exhibiting a mounting element, with a basic body and with at least one locking device which has a detent lug spaced from the basic body, and a connector element which is capable of being received between the detent lug and the basic body in such a manner that it is capable of being fixed in a first of three mutually perpendicular directions in space and capable of being movably supported in the other two directions in space. In other words, the proposed mounting device enables a connection or linkage that is translationally fixed in a first direction in space and translationally movable in two further directions in space.

As a result, a particularly rigid or firm linkage in a first direction, for instance in a Z-direction parallel to the vertical of the vehicle, can be made possible, and, at the same time, compensating motions in a longitudinal direction of the vehicle and/or transverse direction of the vehicle (X-direction and Y-direction) can be permitted. In other exemplary embodiments, the coordinate system of the three directions in space (X, Y, Z) may have a different orientation, though the directions in space are always perpendicular to one another.

By means of the mounting device configured in this way, a relative motion is made possible within the mounting device, in particular instead of between a mounting and the busbar to be fastened. An extent of the scope for motion made possible within the mounting device can be established by a spacing between components of the mounting device, and can be adapted to a respective application.

According to a further aspect, a busbar for a motor vehicle is proposed having at least one mounting device described herein. A busbar is, in particular, a channel which may exhibit and bundle current-carrying cables or cables for signal communication. For instance, such a busbar within a vehicle may constitute a connection between an interface to an external charging station and an energy-storage device of the vehicle. In particular, a busbar may be a high-voltage charging bar for a vehicle that is at least partly electrically powered.

In operation, these busbars may undergo changes of temperature and consequently thermal expansions which can be compensated, at least in part, by means of one or more mounting devices proposed herein. In addition, busbars have manufacturing tolerances which, without an option for compensation of motion, might result in tension forces, for instance in the region of a current-carrying contact. Such an option for compensation of motion can be made available by means of the mounting device proposed herein.

The mounting device comprises substantially two components: on the one hand, the mounting element, and, on the other hand, the connector element. The mounting element may, for instance, have been configured to be fastened to the vehicle or to a vehicle component, in which case the corresponding connector element is, or can be, connected to the busbar in order to enable the linkage between the motor vehicle and the busbar. Conversely, in other embodiments the connector element may have been configured to be, or to have been, fastened to the vehicle, and the corresponding mounting element may have been configured to be, or to have been, fastened to the busbar.

For instance, the basic body of the mounting element may be disc-shaped or ring-shaped, and/or may exhibit fastening means, for instance in the form of one or more tabs or tongues exhibiting at least one recess, by means of which the mounting element is capable of being fixed to the motor vehicle or to the busbar. In such an exemplary embodiment, the connector element may, in particular, have been firmly or rigidly connected to the busbar, so that a connection of the proposed type can be achieved by connecting or fixing the mounting element relative to the connector element.

In an installation situation in a motor vehicle, a busbar may have been fastened by means of the mounting device in such a manner, for instance, that the axis of rotation of the mounting element is arranged parallel to a vertical of the vehicle, in which case a Z-direction of a space-axis system may have been established by this vertical of the vehicle. With respect to the mounting device, the axis of rotation of which extends parallel to this Z-axis, a plane (X-Y-plane) perpendicular to the Z-axis may define a plane of possible degrees of freedom for a motion of the connector element and consequently for a relative motion between the busbar and the motor vehicle.

In one embodiment, the mounting element and/or the connector element is/are capable of being brought into a fixing position by means of a rotary motion about the first space axis. This rotary motion may be a relative motion between the mounting element and the connector element, as a result of which the connector element is movable into the fixing position with respect to the locking device or, to be more precise, with respect to the detent lugs of the locking device. In the fixing position, the connector element has been fixed or positioned in the first space axis, in particular immovably, by means of the mounting element. Degrees of freedom in a plane perpendicular to the first space axis can be utilized for the purpose of compensating for the motion of the mounting element relative to the connector element.

In one embodiment, the connector element is substantially disc-shaped. In particular, the connector element exhibits an at least substantially circular periphery and a thickness in order to favor the rotary motion, in particular within a receiving space, established by locking device, for the connector element. The connector element may be capable of being fastened, or may have been fastened, in particular in or on its central region, to the busbar or to a mounting for a busbar, so that a peripheral edge of the connector element and, in particular, a flat side of the connector element remain free for engagement with the mounting element.

In one embodiment, the spacing between the basic body and the at least one detent lug corresponds substantially to a thickness of the connector element. By virtue of this, a contact between the basic body of the mounting device, on the one hand, and the at least one detent lug of the mounting device, on the other hand, and the connector element can be made available by means of the rotary motion, so that a positive connection, in particular in the direction of the first space axis, has been made possible.

In one embodiment, the connector element has at least one recess. In this case, the recess has been designed, in particular, to correspond to a geometry of the detent lug, so that in the course of a fixing motion, in particular along the first space axis, the connector element is firstly conducted past the detent lugs, or, to be more precise, the detent lugs are positioned in the recesses, until a fixing is, or can be, brought about by means of the rotary motion. By this means, the connector element can be brought into contact with the basic body in order to enable a subsequent rotary motion, without a temporary change of shape of the locking device, or of the detent lugs, being necessary.

In one embodiment, the at least one locking device has been arranged on a peripheral edge of the basic body. As a result of this, the locking device can define a receiving space for the connector element, into which the connector element can be inserted, in particular by means of a motion along the first space axis, before it is, or can be, brought into the fixing position by means of a rotary motion. The detent lug(s) may have been oriented radially inward with respect to the basic body, or with respect to the mounting element, in order to enable a positive connection to the connector element.

In one embodiment, at least two—in particular, three—locking devices have been arranged in evenly distributed manner on the mounting element. By this means, a positive connection, in particular in the direction of the first direction in space, between the mounting element—or, to be more precise, locking device and/or detent lugs—and the connector element can be made at several points, as a result of which a loadable fixing between the mounting element and the connector element is achievable.

In one embodiment, a periphery defined by the locking device is larger than an outside diameter of the connector element. By this means, a scope for motion for the connector element, in particular peripherally, between the locking device, or, to be more precise, flanges of the locking device which are arranged between the detent lug and the mounting device, is provided, in order to enable a compensation of motion within the mounting device in a plane perpendicular to the first space axis.

In one embodiment, the mounting device has a busbar mounting. The busbar mounting may, for instance, have been formed in two parts, so that, for instance, a first at least substantially U-shaped formwork element has been connected to the connector element, in which case a second formwork element, likewise substantially U-shaped, is capable of being fastened with this for the purpose of receiving the busbar. In this case, the formwork elements have been configured, in particular jointly, to encompass the busbar completely and/or to fix it relative to the mounting device. By this means, the mounting device can, for instance, firstly be fastened to the busbar by means of the busbar mounting, in order to be fastened as a whole in the motor vehicle, or the mounting device, or at least a part thereof, can firstly be fastened in the motor vehicle, and the busbar can subsequently be arranged on the mounting device by means of the busbar mounting. By this means, a flexible mounting system for the busbar is made available within the motor vehicle, which enables simultaneously a compensation of motion in at least one plane and a locking in an axis perpendicular to this plane.

In one embodiment, the mounting device has been arranged on a bend of the busbar. In such an embodiment, the busbar mounting has been adapted, in particular, to the geometry, or to a contour, in the longitudinal extent of the busbar, or to the motion of the busbar, so that a firm or rigid connection between the busbar mounting, the busbar and the mounting device, or, to be more precise, the connector element or mounting element, can be achieved.

Further advantages and possible applications of the invention arise out of the following description in conjunction with the figures.

### BRIEF DESCRIPTION OF THE DRAWINGS

FIG. 1 is a schematic representation of an exemplary embodiment of a mounting device according to the invention for a busbar, in an exploded view.

FIG. 2 shows the mounting device from FIG. 1 in an exemplary fixing position.

### DETAILED DESCRIPTION OF THE DRAWINGS

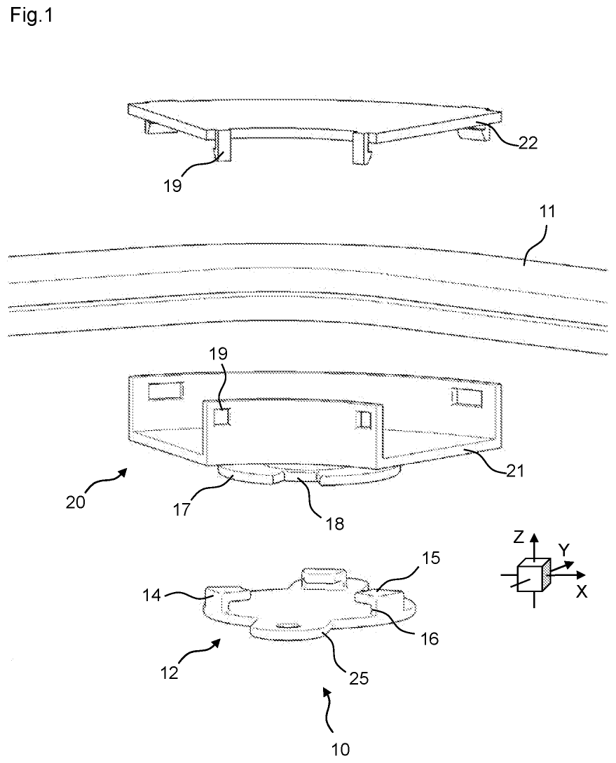

FIG. 1 shows a mounting device 10 for a busbar 11, in particular for a motor vehicle, according to a first exemplary embodiment of the present disclosure, in an exploded view.

The mounting device 10 has a mounting element 12 with a basic body 13 and with at least one—in the exemplary embodiment represented, three—locking devices 14. The locking devices 14 are arranged on a peripheral edge of the basic body 13 and arranged in an evenly distributed manner on the mounting element, or, to be more precise, on the basic body 13 thereof, the locking devices 14 each having a detent lug 15 oriented toward a middle of the basic body 13. The detent lugs 15 are each spaced from the basic body 13 by means of a flange 16 of the locking device 14.

The mounting device further includes a connector element 17 which is capable of being received between the detent lugs 15 and the basic body 13 in such a manner that it is capable of being fixed in a first direction in space Z of three mutually perpendicular directions in space X, Y, Z and capable of being movably supported in the other two directions in space X, Y. For this purpose, a periphery of the connector element 17 is smaller than a periphery, or receiving space, defined by the locking devices 14. Directions in space X, Y in this case may, for instance, be oriented parallel to a longitudinal extent and to a transverse extent of the busbar 11, the Z-direction being oriented parallel to a vertical extent of the busbar 11.

The connector element 17 is substantially disc-shaped and has at least one recess 18 which has been configured to receive, in each instance, a detent lug 15, so that the basic body 13 and the connector element 17 can be brought into abutment, in particular in a planar manner. The spacing between the basic body 13 and the at least one detent lug 15 corresponds substantially to a thickness of the connector element 17, so that a positive connection can be made possible, in particular in the Z-direction or, to be more precise, perpendicular to an X,Y-plane defined by the basic body 13.

In the exemplary embodiment represented, a formwork element 21 has been connected to the connector element 17 and has been configured to encompass the busbar 11 at least partly and to fix it. A second formwork element 22 has been configured to encompass the busbar at least partly and is capable of being connected to the first formwork element 21 in such a manner that the busbar 11 is capable of being fastened, by means of the busbar mounting 20 formed from the two formwork elements 21, 22, with the mounting device 10 in relation to the connector element 17 and in a fixing position. In the exemplary embodiment represented, detent devices 19 have been provided here on the formwork elements 21, 22 or, to be more precise, on the busbar mounting 20.

For the purpose of fastening the mounting element 12, or, to be more precise, the mounting device 10, within the motor vehicle, the mounting element 12 has two tabs 25 arranged opposite one another, by means of which a linkage can be made possible, for instance by means of a screw coupling.

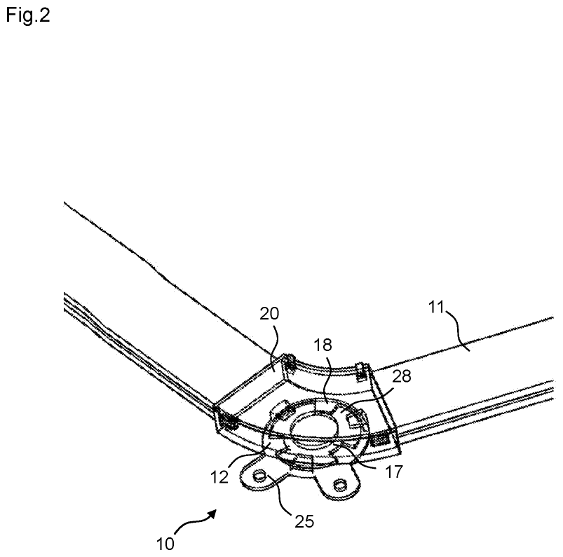

In FIG. 2, an exemplary busbar 11 for a motor vehicle, with a mounting device 10 from FIG. 1, is shown in a wire-frame representation, wherein the busbar mounting 20 encompasses the busbar 11 at a bend, in order to hold it.

The mounting device 10 has been represented in a fixing position in which the locking device 14, or the detent lugs 15 thereof, are in engagement with holding regions 28 arranged between the recesses 18 of the connector element 17, in order to fix the connector element 17 translationally in the first direction in space Z. In this case, the connector element 17 has been fixed between the detent lugs 15 and the basic body in such a manner that a motion in the first direction Z is blocked, but degrees of freedom in the plane in which the connector element 17 is situated, or which is predetermined by the discoid shape of the connector element 17, exist.

The first direction Z is established by the axis of rotation of the mounting element 12 and the connector element 17; the other two directions in space X, Y are each perpendicular to the first direction Z and are perpendicular to one another.

By way of example, in this illustration the tabs 25 for fastening have been represented at different points on the mounting element 12 or, to be more precise, on the basic body 13.

### LIST OF REFERENCE SYMBOLS

10 mounting device
11 busbar
12 mounting element
13 basic body
14 locking device
15 detent lug
16 flange
17 connector element
18 recess
19 detent device
20 busbar mounting
21, 22 formwork element
25 tab
28 holding region
X, Y, Z direction in space

1.-11. (canceled)

12. A mounting device for a busbar, comprising:
a mounting element having a basic body and at least one locking device which includes a detent lug spaced from the basic body; and
a connector element which is capable of being received between the detent lug and the basic body so as to be fixable in a first of three mutually perpendicular directions in space and movably supportable in the other two directions in space.

13. The mounting device according to claim 12, wherein
the mounting element and/or the connector element are capable of being brought into a fixing position via a rotary motion about the first space axis.

14. The mounting device according to claim 12, wherein the connector element is substantially disc-shaped.

15. The mounting device according to claim 12, wherein
the spacing between the basic body and the at least one detent lug corresponds substantially to a thickness of the connector element.

16. The mounting device according to claim 12, wherein the connector element has at least one recess.

17. The mounting device according to claim 12, wherein
the at least one locking device is arranged on a peripheral edge of the basic body.

18. The mounting device according to claim 12, wherein at least two locking devices are arranged in an evenly distributed manner on the mounting element.

19. The mounting device according to claim 12, wherein at least three locking devices are arranged in an evenly distributed manner on the mounting element.

20. The mounting device according to claim 18, wherein a periphery defined by the locking devices is larger than an outside diameter of the connector element.

21. The mounting device according to claim 12, wherein the mounting device comprises a busbar mounting.

22. A motor vehicle, comprising:
a busbar; and
at least one mounting device for the busbar, the mounting device comprising:
a mounting element having a basic body and at least one locking device which includes a detent lug spaced from the basic body; and
a connector element which is capable of being received between the detent lug and the basic body so as to be fixable in a first of three mutually perpendicular directions in space and movably supportable in the other two directions in space.

23. The motor vehicle according to claim 22, wherein the mounting device is arranged on a bend of the busbar.
